(19) United States
(12) Patent Application Publication
(10) Pub. No.: US 2013/0322093 A1
(43) Pub. Date: Dec. 5, 2013

(54) LIGHT APPARATUS TRIM WIREFORM

(71) Applicants: Keisuke Ono, Houston, TX (US); Anthony J. Gutierrez, Houston, TX (US)

(72) Inventors: Keisuke Ono, Houston, TX (US); Anthony J. Gutierrez, Houston, TX (US)

(21) Appl. No.: 13/486,515

(22) Filed: Jun. 1, 2012

(51) Int. Cl. F21V 21/08; F21V 21/13; B23P 17/04; F21V 7/00; F21V 21/00

(52) U.S. Cl. 362/341; 362/382; 362/396; 29/428; 248/316.7

(57) ABSTRACT

The present disclosure describes a downlight apparatus that includes a downlight component. A wireform housing may be disposed on an outer surface of the downlight component. A self-locking retention wireform may be coupled to the wireform housing. The self-locking retention wireform may include a locked arrangement, with the locked arrangement including a pre-loaded spring force secured by at least one locking mechanism of the self-locking retention wireform. The self-locking retention wireform may also include an unlocked arrangement, with the unlocked arrangement operable to secure the downlight component within the downlight fixture.

### FIELD

Embodiments described herein are related generally to securing downlight apparatuses and associated methods.

### BACKGROUND

Typical downlight fixtures are recessed into a ceiling. Holes in the surface of the ceiling are usually cut to provide an opening through which light from the fixture can enter the room. A reflector, finishing trim, or other downlight component may be installed within the downlight fixtures through the ceiling. Typically, wireforms are used to secure the reflector, for example, within the downlight fixture, or to pull the finishing trim flush with the ceiling. In many cases, however, the wireform must be manually compressed and held during the installation process. Holding the wireform in a compressed position during installation can be difficult and cumbersome, particularly while attempting to align the reflector or trim within the ceiling cut-out and the reflector or trim within the downlight fixture itself.

### BRIEF DESCRIPTION OF THE DRAWINGS

FIGS. 1a and 1b show an example self-locking wireform in an unlocked position, according to aspects of the present disclosure.

FIG. 1c shows a front view of the example self-locking wireform of FIGS. 1a and 1b in a locked position, according to aspects of the present disclosure.

FIGS. 2a and 2b show an example self-locking wireform being installed into an example mounting feature of a downlight fixture, according to aspects of the present invention.

FIG. 3 shows an example downlight fixture assembly incorporating aspects of the present disclosure.

FIGS. 4a and 4b show an downlight apparatus with bulb according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Embodiments described herein are related generally to securing downlight apparatuses and associated methods.

Hereinafter, embodiments will be described with reference to the drawings. Each drawing is a schematic view for describing an embodiment of the present disclosure and promoting the understanding thereof. The drawings should not be seen as limiting the scope of the disclosure. In each drawing, although there are parts differing in shape, dimension, ratio, and so on from those of an actual apparatus, these parts may be suitably changed in design taking the following descriptions and well-known techniques into account.

The present invention is directed to a downlight apparatus that includes a self-locking retention wireform for easy installation. The downlight apparatus may include, for example, a downlight component, such as a reflector body or a finishing trim, that includes a wireform housing disposed on an outer surface. A self-locking retention wireform may be coupled to or housed in the wireform housing. The self-locking retention wireform may include a locked arrangement for use during installation of the downlight component within a downlight fixture. The self-locking retention wireform may maintain the locked arrangement without a user manually compressing the wireform. The self-locking retention wireform may also include an unlocked arrangement, wherein the unlocked arrangement is operable to secure the downlight component within the downlight fixture. As will be discussed below, the self-locking retention wireform may automatically switch from the locked arrangement to the unlocked arrangement when it is installed in a mounting feature of a downlight fixture.

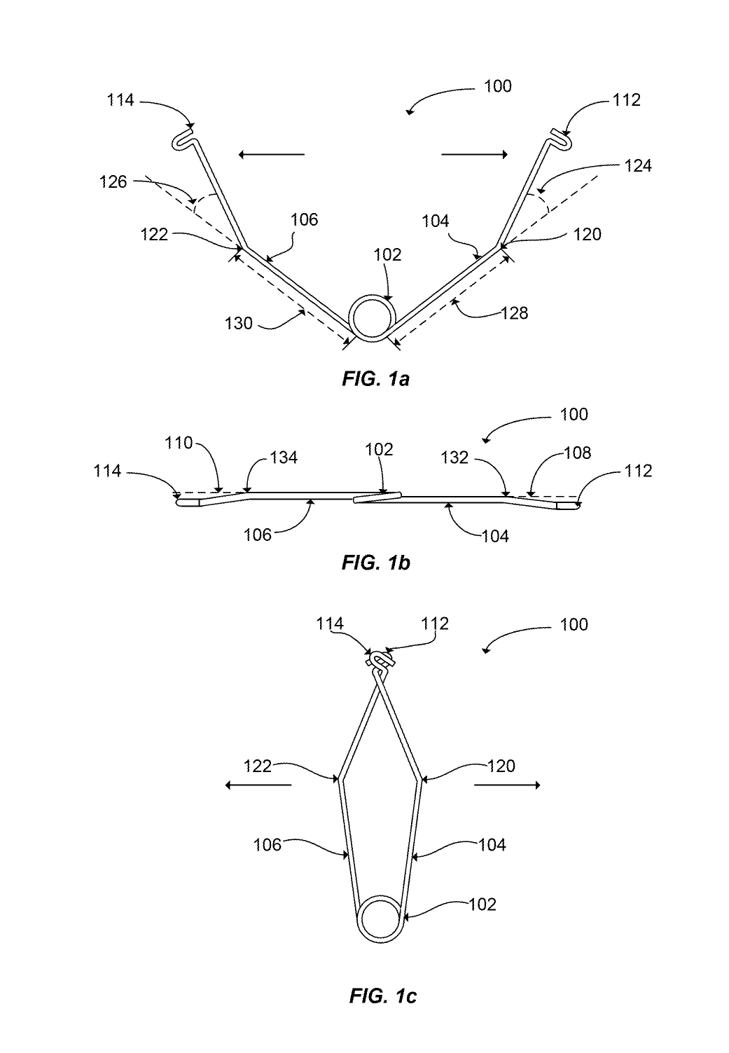

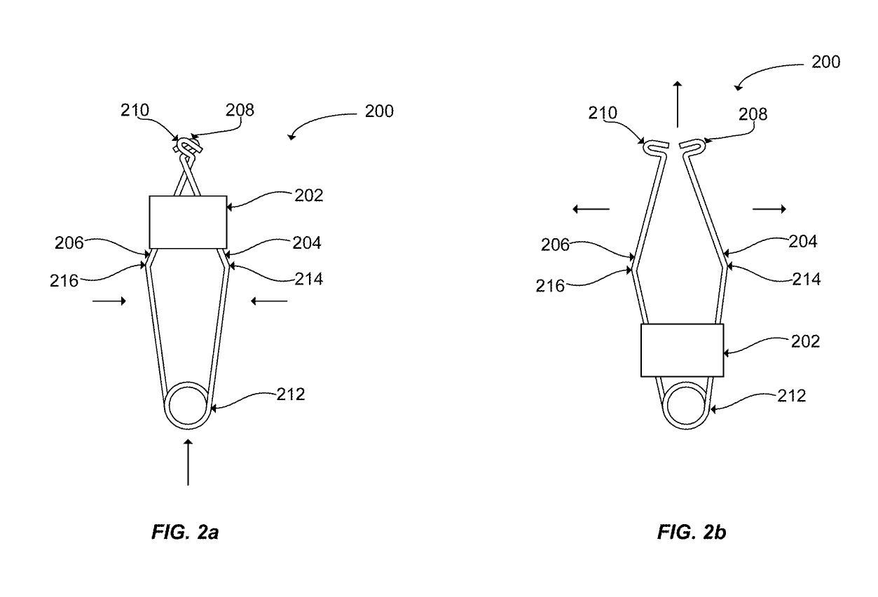

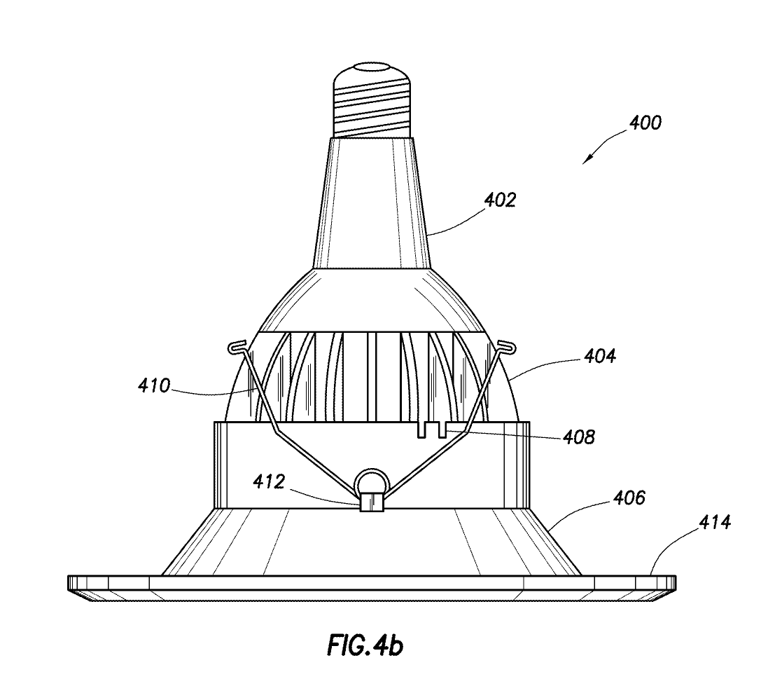

FIGS. 1a-c illustrate an example self-locking retention wireform 100. The self-locking retention wireform 100 may comprise a coiled wire or spring 102 positioned between a first arm 104 and a second arm 106. In certain embodiments, the self-locking retention wireform 100, including the spring 102, first arm 104 and second arm 106, may be manufactured out of a single piece of wire. The spring 102 may urge the first arm 104 and second arm 106 away from each other in a first plane, as indicated by the arrows in FIG. 1a. The first arm 104 may include a first bend 120 toward the second arm 106, and the second arm 106 may include a second bend 122 toward the first arm 104. The distance 128 of the first bend 120 from the spring 102 may be the same as the distance 130 of the second bend 122 from the spring 102, within mechanical tolerances. Likewise, the angle 124 of the first bend 120 may be the same as the angle 126 of the second bend 122, within mechanical tolerances. The distances and angles used for the self-locking retention wireform 100 may depend on the particular downlight application, as would be appreciated by one of ordinary skill in the art in view of this disclosure. As will be discussed below with respect to FIG. 4, the first bend 120 and the second bend 122 may create landing surfaces on which the self-locking retention wireform 100 will engage with a mounting feature of a downlight fixture.

The first arm 104 of the self-locking retention wireform 100 may include a first locking mechanism 112 disposed at an end opposite the spring 102. Likewise, the second arm 106 of the self-locking retention wireform 100 may include a second locking mechanism 112 disposed at an end opposite the spring 102. As will be described below, the first locking mechanism 112 and the second locking mechanism 106 may be used to secure the first arm 104 in place relative to the second arm 106 when the self-locking retention wireform 100 is in a locked arrangement. In the embodiment shown in FIGS. 1a-c, the locking mechanisms may comprise hooks, with the open end of each hook facing toward to opposite arm. For example, the open end of locking mechanism 112 on the first arm 104 is facing second arm 106, and the open end of locking mechanism 114 on the second arm 106 is facing the first arm 104. Other configurations of locking mechanisms are possible—including the placement of the locking mechanisms on the wireform, the direction of locking mechanisms, and the type of locking mechanism.

FIG. 1b shows a top view of the self-locking retention wireform 100. As can be seen, in addition to the first bend 120 and the second bend 122, the self-locking retention wireform 100 may include additional bends 132 and 134 at angles 108 and 110 respectively. The bends 132 and 134 may be in a second plane perpendicular to the first plane. Like the first bend 120 and the second bend 122, the bends 132 and 134 may be at the same angle within mechanical tolerances. Likewise, the bends 132 and 134 may be at distances 128 and 130, respectively, from the spring. In certain embodiments, the bends 132 and 134 may help facilitate the locking arrangement of the self-locking retention wireform 100. In particular, when in the locked arrangement, as shown in FIG. 1c, the bends 132 and 134 may create tension between the first arm 104 and the second arm 106 in the second plane.

FIG. 1c shows the example self-locking retention wireform 100 in a locked arrangement. As can be seen, in the locked arrangement, the first arm 104 and the second arm 106 may be secured together using the first locking mechanism 112, the second locking mechanism 114, the spring force of the spring 102, and the spring force of the first arm 104 and the second arm 106 cause by the bends 132 and 134. Placing the self-locking retention wireform 100 into a locked arrangement may first comprise pre-loading the spring force from the spring 102 by pinching the first arm 104 and the second arm 106 together. Once the spring force has been pre-loaded, at least one locking mechanism of the self-locking retention wireform may be engaged to prevent the release of the pre-loaded spring force. In the embodiment shown, the locking mechanisms of the self-locking retention wireform 100 may be engaged by pinching the arms together until the first arm 104 overlaps the second arm 106, and the looped end of the first locking mechanism 112 passes the looped end of the second locking mechanism 114. The first locking mechanism 112 may then be moved behind the second locking mechanism 114. When the arms 104 and 106 are released, the first locking mechanism 112 and the second locking mechanism 114 may engage, preventing the pre-loaded spring force of the spring 102 from separating the first arm 104 and the second arm 106.

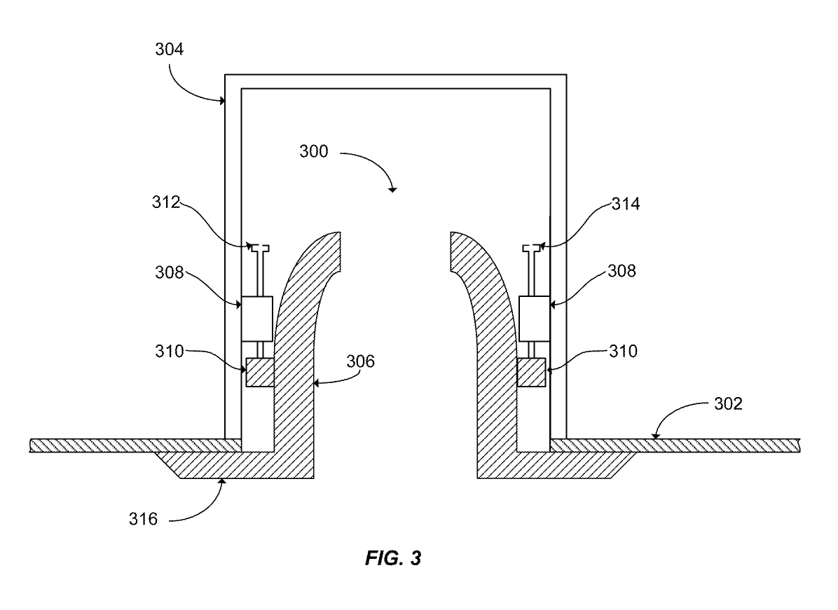

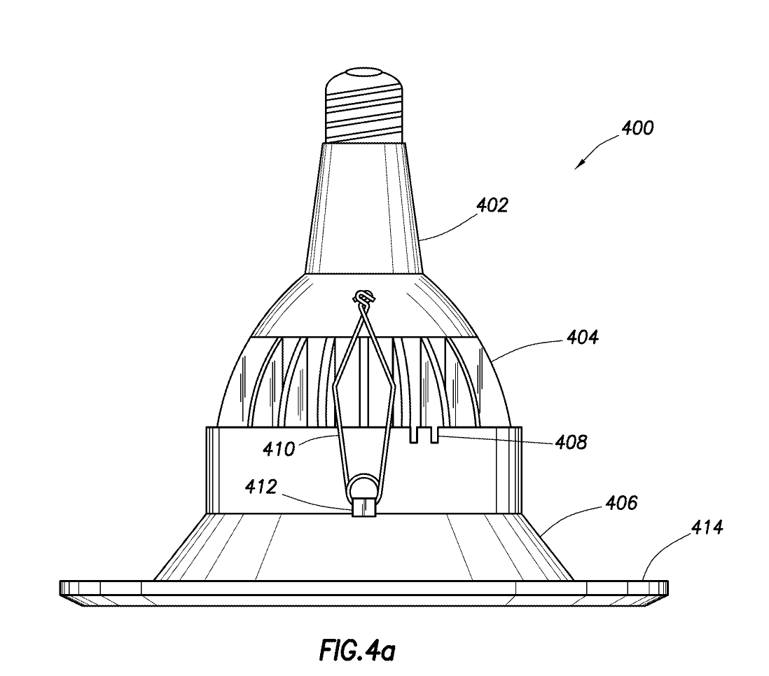

FIGS. 2a-b illustrate the functionality of an example self-locking retention wireform 200 and an example method for using the self-locking retention wireform 200 within an example mounting feature 202. As described above and seen in FIG. 2a, the method may include first placing the self-locking retention wireform into a locked arrangement. As also described above, placing a self-locking retention wireform into a locked arrangement may include pre-loading a spring force of the self-locking retention wireform, and engaging a locking mechanism of the self-locking retention wireform to prevent the release of the pre-loaded spring force until the self-locking retention wireform is inserted into a mounting feature, such as mounting feature 202. The mounting feature 202 may be integral, for example, with a downlight fixture, as will be described with respect to FIG. 3. The mounting feature 202 may further comprise a rectangular element with a solid frame that defines an opening through which the self-locking retention wireform 200 can be inserted.

As can be seen in FIG. 2b, inserting the self-locking retention wireform 200 into the mounting feature 202 may cause the self-locking retention wireform 200 to switch to an unlocked arrangement. In the embodiment shown, inserting the self-locking retention wireform 200 into the mounting feature 202 may cause at least one landing surface 204 and 206 on the arms of the self-locking retention wireform 200 to contact the mounting feature 202. The upward force on the self-locking retention wireform 200 and the angle of the wire at the landing surfaces 204 and 206 may cause the arms to be urged further together. Once urged together, the looped end of the first locking mechanism 208 may pass behind the looped end of the second locking mechanism 210, allowing the arms of the self-locking retention wireform 200 to disengage and the self-locking retention wireform 200 to switch to an unlocked arrangement.

Once the first locking mechanism 208 and the second locking mechanism 210 disengage, the pre-loaded spring force from the spring 212 may be released and urge the arms apart. FIG. 2b shows the self-locking retention wireform 200 inserted into the mounting feature 202 such that the bends 214 and 216 of the arms are above the mounting feature 202. The outward force on the arms of the self-locking retention wireform 200 by the spring 212, and the angle of the arms below the bends 414 and 416, may cause the self-locking retention wireform 200 to be pulled upwards relative to the mounting feature 202. If, as can be seen in FIG. 3, the self-locking retention wireform 200 were coupled to a downlight component, such as a reflector, and the mounting feature 202 coupled to a downlight fixture, the downlight component would be secured within the downlight feature using the self-locking retention wireform in the unlocked arrangement.

Advantageously, a self-locking retention wireform incorporating aspects of the present invention may result in easier installations of downlight fixture elements, and any other elements that utilize retention wireforms. In particular, as can be seen in FIGS. 2a and 2b, once the self-locking retention wireform 200 is in the locked arrangement, the arms of the self-locking retention wireform 200 no longer need to be manually pinched together. By relieving the need to pinch the arms of the wireform together, hand placement during the installation process may be changed, leading to a less awkward grips and quicker installation. Likewise, because the self-locking retention wireform 200 automatically switches from the locked arrangement to the unlocked arrangement when inserted into the mounting feature, the installation process can be simplified to aligning the self-locking retention wireform with the mounting feature and pressing upwards.

FIG. 3 illustrates an example downlight apparatus 300 incorporating self-locking retention wireforms 312 and 314, according to aspects of the present disclosure. The self-locking retention wireforms 312 and 314 may be coupled to a downlight apparatus 300. The downlight apparatus 300 may include a downlight reflector 306, finishing trim for a downlight fixture 316, or a combination of the two. In FIG. 3, the reflector 306 may include wireform housings 310 disposed on an outer surface. The self-locking retention wireforms 312 and 314 may be coupled to the reflector 306 through the wireform housings 310. As can be seen, the self-locking retention wireforms 312 and 314 may be inserted into mounting features 308, urging the reflector 306 upwards. The mounting features may be coupled for example to a downlight fixture 304 installed above a ceiling 302. The self-locking retention wireforms 312 and 314 may urge the downlight apparatus 300 upwards relative to the downlight fixture 304, such that the finishing trim 316 is pulled flush with the ceiling 302.

FIGS. 4a and 4b illustrate an example downlight apparatus 400 incorporating aspects of the present disclosure. As can be seen in FIG. 4a, the downlight apparatus includes a detachable accent assembly 406 including a reflector and a trim piece 414. The detachable accent assembly 406 may be coupled to a bulb 402 through a snap-fit mechanism 408. The bulb 402 may include fins 404, for example. As can be seen, the detachable accent assembly 406 may include a wireform housing 412 disposed on an outer surface. The wireform housing 412 may hold in place a retention wireform 410. The retention wireform 410 may be placed in a locked position, such as in FIG. 4a, when the downlight apparatus 400 is to be installed within a downlight fixture. Once the downlight apparatus 400 is installed within a downlight fixture, for example, the retention wireform 410 may automatically switch to an unlocked position, which pulls the trim piece 414 flush with the ceiling.

While certain embodiments of a light apparatus trim wireform have been described, these embodiments have been presented by way of example only, and are not intended to limit the scope of the disclosure. Indeed, the novel systems described herein may be embodied in a variety of other forms; furthermore, various omissions, substitutions and changes in the form of the systems described herein may be made without departing from the spirit of the disclosure. The accompanying claims and their equivalent are intended to cover such forms or modifications as would fall within the scope and spirit of the disclosure.

What is claimed is:

1. A downlight apparatus, comprising:
a downlight component;
a wireform housing disposed on an outer surface of the downlight component; and
a self-locking retention wireform coupled to the wireform housing, wherein the self-locking retention wireform comprises:
a locked arrangement, wherein the locked arrangement comprises a pre-loaded spring force secured by at least one locking mechanism of the self-locking retention wireform; and
an unlocked arrangement, wherein the unlocked arrangement is operable to secure the downlight component within the downlight fixture.

2. The downlight apparatus of claim 1, wherein the downlight component includes at least one of a reflector and a finishing trim.

3. The downlight apparatus of claim 1, wherein the self-locking retention wireform comprises a spring positioned between a first arm and a second arm, wherein the spring force urges the first arm away from the second arm in a first plane.

4. The downlight apparatus of claim 3, wherein in the locked arrangement, the first arm is locked in place relative to the second arm.

5. The downlight apparatus of claim 4, wherein the self-locking retention wireform includes a first locking mechanism at an end of the first arm opposite the spring, and a second locking mechanism at an end of the second arm opposite the spring, and wherein in the locked arrangement the first locking mechanism and the second locking mechanism engage to secure the pre-loaded spring force.

6. The downlight apparatus of claim 5, wherein the first locking mechanism and the second locking mechanism comprise hooks.

7. The downlight apparatus of claim 6, wherein:
the first arm includes a first bend towards the second arm in the first plane, wherein the first bend creates a first landing surface when the self-locking retention wireform is in the locked arrangement; and
the second arm includes a second bend toward the first arm in the first plane, wherein the second bend creates a second landing surface when the self-locking retention wireform is in the locked arrangement.

8. The downlight apparatus of claim 7, wherein the first landing surface and the second landing surface are operable to engage with a mounting feature in the downlight fixture during installation of the downlight component.

9. The downlight apparatus of claim 8, wherein the mounting feature causes the self-locking retention wireform to automatically switch from the locked arrangement to the unlocked arrangement.

10. An method for securing a downlight apparatus, comprising:
placing a self-locking retention wireform into a locked arrangement, wherein the self-locking retention wireform is coupled to a downlight component;
inserting the self-locking retention wireform into a mounting feature, wherein the mounting feature is coupled to a downlight fixture, and wherein inserting the self-locking retention wireform into the mounting feature causes the self-locking retention apparatus to switch to an unlocked arrangement; and
securing the downlight component in the downlight feature using the self-locking retention wireform in the unlocked arrangement.

11. The method of claim 10, wherein the step of placing the self-locking retention wireform into a locked arrangement includes the steps of:
pre-loading a spring force of the self-locking retention wireform, and engaging a locking mechanism of the self-locking retention wireform to prevent the release of the pre-loaded spring force.

12. The method of claim 11, wherein the self-locking retention wireform comprises a spring positioned between a first arm and a second arm, wherein the spring force urges the first arm away from the second arm in a first plane.

13. The method of claim 12, wherein the step of pre-loading the spring force includes forcing the first arm toward the second arm.

14. The method of claim 13, wherein the self-locking retention wireform includes a first locking mechanism at an end of the first arm opposite the spring, and a second locking mechanism at an end of the second arm opposite the spring, and wherein the step of engaging a locking mechanism of the self-locking retention wireform to prevent the release of the pre-loaded spring force includes causing the first locking mechanism to engage with the second locking mechanism

15. The method of claim 14, wherein the first locking mechanism and the second locking mechanism comprise hooks.

16. The method of claim 15, wherein:
the first arm includes a first bend towards the second arm, wherein the first bend creates a first landing surface when the self-locking retention wireform is in the locked arrangement; and
the second arm includes a second bend toward the first arm, wherein the second bend creates a second landing surface when the self-locking retention wireform is in the locked arrangement.

17. The method of claim 16, wherein the step of inserting the self-locking retention wireform into a mounting feature causes at least one of the first landing surface and the second landing surface to contact the mounting feature.

18. The method of claim 17, wherein causing at least one of the first landing surface and the second landing surface to contact the mounting feature causes the first locking mechanism and the second locking mechanism to disengage.

19. A self-locking retention wireform, comprising:
a first arm;
a second arm;
a spring positioned between the first arm and the second arm, wherein the spring force urges the first arm away from the second arm in a first plane;
a first locking mechanism at an end of the first arm opposite the spring; and
a second locking mechanism at an end of the second arm opposite the spring;
wherein the self-locking retention wireform includes a locked arrangement, wherein the locked arrangement comprises a pre-loaded spring force secured by engaging the first locking mechanism and the second locking mechanism; and

20. The self-locking retention wireform of claim 18, wherein the self-locking retention wireform further comprises an unlocked arrangement, wherein insertion of the self-locking retention wireform into a mounting feature of a downlight fixture causes the self-locking retention wireform to automatically switch to the unlocked arrangement.
